(19) United States
(12) Patent Application Publication
(10) Pub. No.: US 2015/0362661 A1
(43) Pub. Date: Dec. 17, 2015

(54) LED BACKLIGHT ASSEMBLY SUITABLE OF MIDDLE OR SMALL SIZE LCD DISPLAY

(71) Applicant: Chih-Wei Wu, Miaoli city (TW)

(72) Inventor: Chih-Wei Wu, Miaoli city (TW)

(21) Appl. No.: 14/303,618

(22) Filed: Jun. 13, 2014

(51) Int. Cl. F21V 8/00

(52) U.S. Cl. CPC G02B 6/0068; G02B 6/0051; G02B 6/0073; G02B 6/0053; G02B 6/0056; G02B 6/0016

(57) ABSTRACT

An LED backlight assembly suitable of middle or small size LCD displays comprises a light guiding plate; two LED lighting bars; a reflecting film; a light dispersing film; two parallel prism films installed on an upper side of the light dispersing film; each prism film being formed with a plurality of parallel prism posts; and a light enhancing polarizing film. A diagonal line of the LED backlight plate is smaller than 12 inches. In use, an LCD display is arranged on an upper side of the light enhancing polarizing film so that the light from the LED backlight plate is incident into the LCD display to have a light effect. The two lateral sides of the light guiding plate near the two LED lighting bars are arranged with textures for concentrating light from the LED lighting bars.

### FIELD OF THE INVENTION

The present invention related to backlight plates, and in particular to an LED backlight assembly suitable of middle or small size LCD display.

### BACKGROUND OF THE INVENTION

In the prior art, the middle or small sized LED backlight plate assembly is only light source which is incident form a longitudinal side or a lateral side of the plate.

As the light is incident from a lateral side thereof, the plate assembly include a light guiding plate, a reflecting film, a light dispersing film, and at least one light guiding plate. The principle is that the light from the LED lighting bar is incident into the light plate from a periphery thereof. The light is guided into a whole surface of the lighting plate so that the light can be uniformly distributed in the whole surface. However, current LED lighting assembly uses only one lighting bar. This way causes that the light cannot be distributed uniformly and the light intensity is weak. Therefore, the whole light efficiency is reduced.

### SUMMARY OF THE INVENTION

Accordingly, to improve the above mentioned prior art defects, the present invention provides an flexible stuffing box parking assembly, wherein the LED lighting bars are installed at two sides of the LED backlight plat. Moreover, two sides of the light guiding plate 20 near the two LED lighting bars 10 are arranged with textures for concentrating light from the LED lighting bars 10. By aforesaid arrangement, light is incident into the backlight plate from two sides thereof and thus the light intensity is enhanced by 2 to 2.5 times than those having only one light bars. Furthermore, since lighting bars 10 are installed at two sides of the plate, and thus the light is uniformly distributed. As a whole, the directivity of the light is increased than the prior art structure.

To achieve above object, the present invention provides an LED backlight assembly suitable of middle or small size LCD display comprising: An LED backlight assembly suitable of middle or small size LCD displays comprising: a light guiding plate arranged for guiding light from two lateral sides thereof to transmit along a surface of the light guiding plate; two LED lighting bars arranged at the two lateral sides of the backlight assembly for emitting light; light from the LED lighting bars being incident into the light guiding plate; a reflecting film arranged below the light guiding plate for reflecting light from the light guiding plate to an upper side of the light guiding plate; a light dispersing film arranged on an upper side of the light guiding plate for receiving light from the light guiding plate for dispersing the light as the light passing through the light dispersing film so that the light is uniformly distributed; two parallel prism films installed on an upper side of the light dispersing film; each prism film being formed with a plurality of parallel prism posts; orientations of the prism posts on the two prism films being vertical to one another; the function of the two prism films causing that light from the light dispersing film and passing through the two prism films emits out with a direction vertical to surfaces of the two prism films so that the light leaving the prism films is usable. a light enhancing polarizing film arranged on an upper side of the two parallel prism films for polarizing the light emitting from the two prism films so that the light intensity thereof will be enhanced; wherein a diagonal line of the LED backlight plate is smaller than 12 inches. wherein in use, an LCD display is arranged on an upper side of the light enhancing polarizing film so that the light from the LED backlight plate is incident into the LCD display to have a light effect.

In the present invention, the size (a length of a diagonal line) of the LED backlight plate is a between 5 to 12 inches or smaller than 5 inches. Preferably, the length is smaller than 5 inches. Preferably the length is 10.2 inches, 7 inches, or 4.3 inches.

### BRIEF DESCRIPTION OF THE DRAWINGS

FIG. 1 is a schematic view showing the embodiment of the present invention.

FIG. 2 is a assembled view showing that the present invention is used with an LCD display.

FIG. 3 is a schematic view showing a plane view of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

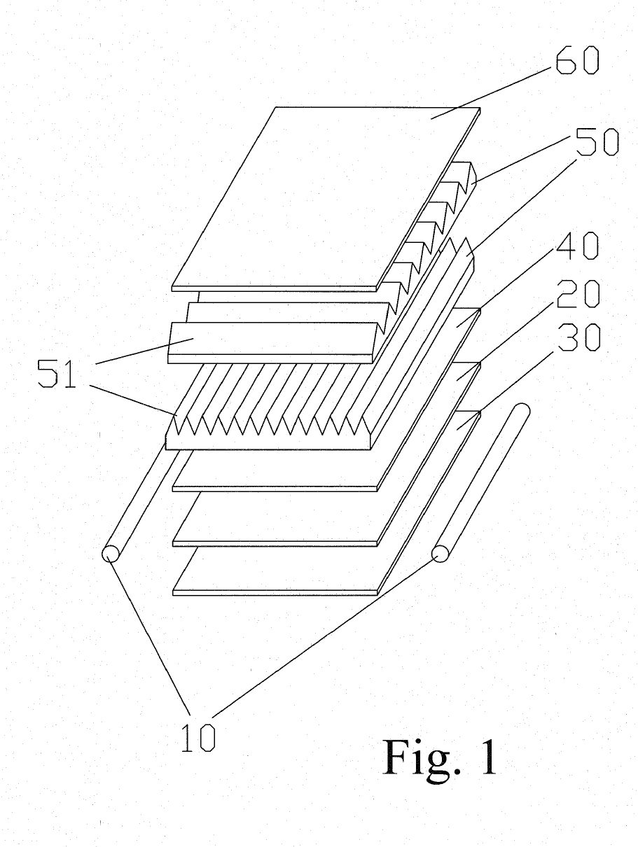

With reference to FIGS. 1 to 3, the structure of the present invention is illustrated. The present invention includes the following elements.

With reference to FIGS. 1 to 3, an LED backlight assembly suitable of middle or small size LCD display according to the present invention is illustrated. The present invention has following elements.

Two LED lighting bars 10 are arranged at two sides of the backlight assembly for emitting light.

A light guiding plate 20 is arranged between the two LED lighting bars 10 for guiding light from the two LED lighting bars 10 along a surface of the light guiding plate 20. In the present invention, two sides of the light guiding plate 20 near the two LED lighting bars 10 are arranged with textures for concentrating light from the LED lighting bars 10.

A reflecting film 30 is arranged below the light guiding plate 20 for reflecting light from the light guiding plate 20 to an upper side of the light guiding plate 20.

A light dispersing film 40 is arranged on an upper side of the light guiding plate 20 for receiving light from the light guiding plate 20 for dispersing the light as the light passing through the light dispersing film 40 so that the whole structure presents uniform light distribution.

Two parallel prism films 50 are installed on an upper side of the light dispersing film 40. Each prism film 50 is formed with a plurality of parallel prism posts 50. Orientations of the prism posts 51 on the two prism films 50 are vertical to one another. The function of the two prism films 50 cause that the light from the light dispersing film 40 and passing through the two prism films 50 will emit out with a direction vertical to surface of the two prism films 50 so that the light leaving the prism films 50 is usable.

A light enhancing polarizing film 60 is arranged on an upper side of the two parallel prism films 50 for polarizing the light emitting from the two prism films 50 so that the light intensity thereof will be enhanced.

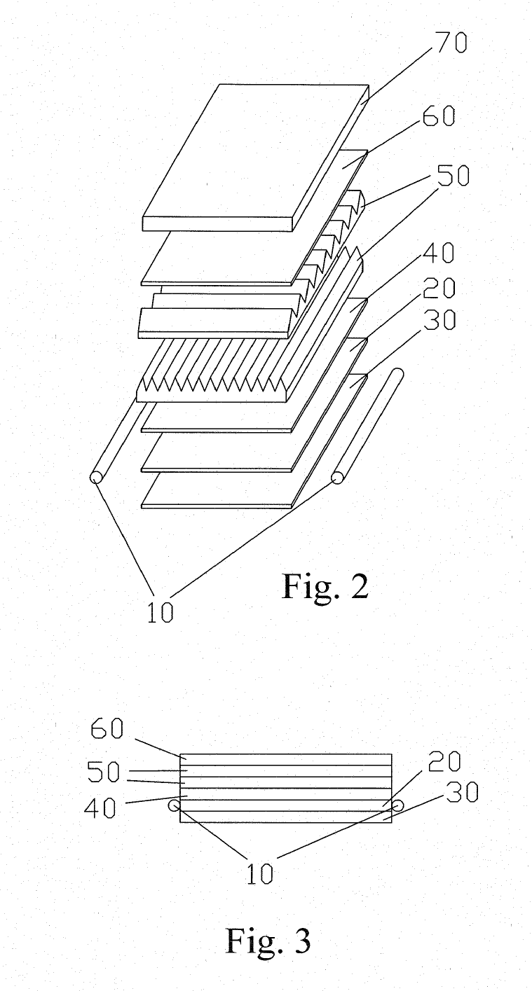

With reference to FIG. 2, the use of the present invention is illustrated. In use of the present invention, an LED display 70 is arranged on an upper side of the light enhancing polarizing film 60 so that the light from the LED backlight plate is incident into the LCD display to have a desired light effect.

In the present invention, the size (a length of a diagonal line) of the LED backlight plate is a between 5 to 12 inches or smaller than 5 inches. Preferably, the length is smaller than 5 inches. Preferably the length is 10.2 inches, 7 inches, or 4.3 inches.

The main features of the present invention are that the LED lighting bars 10 are installed at two sides of the LED backlight plat. Moreover, two sides of the light guiding plate 20 near the two LED lighting bars 10 are arranged with textures for concentrating light from the LED lighting bars 10. By aforesaid arrangement, light is incident into the backlight plate from two sides thereof and thus the light intensity is enhanced by 2 to 2.5 times than those having only one light bars. Furthermore, since lighting bars 10 are installed at two sides of the plate, and thus the light is uniformly distributed. As a whole, the directivity of the light is increased than the prior art structure.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An LED backlight assembly suitable of middle or small size LCD displays comprising:
a light guiding plate arranged for guiding light from two lateral sides thereof to transmit along a surface of the light guiding plate;
two LED lighting bars arranged at the two lateral sides of the backlight assembly for emitting light; light from the LED lighting bars being incident into the light guiding plate;
a reflecting film arranged below the light guiding plate for reflecting light from the light guiding plate to an upper side of the light guiding plate;
a light dispersing film arranged on an upper side of the light guiding plate for receiving light from the light guiding plate for dispersing the light as the light passing through the light dispersing film so that the light is uniformly distributed;
two parallel prism films installed on an upper side of the light dispersing film; each prism film being formed with a plurality of parallel prism posts; orientations of the prism posts on the two prism films being vertical to one another; the function of the two prism films causing that light from the light dispersing film and passing through the two prism films emits out with a direction vertical to surfaces of the two prism films so that the light leaving the prism films is usable;
a light enhancing polarizing film arranged on an upper side of the two parallel prism films for polarizing the light emitting from the two prism films so that the light intensity thereof will be enhanced; and
wherein a diagonal line of the LED backlight plate is smaller than 12 inches; and
wherein in use, an LCD display is arranged on an upper side of the light enhancing polarizing film so that the light from the LED backlight plate is incident into the LCD display to have a light effect.

2. The LED backlight assembly suitable of middle or small size LCD displays as claimed in claim 1, wherein the two lateral sides of the light guiding plate near the two LED lighting bars are arranged with textures for concentrating light from the LED lighting bars.

3. The LED backlight assembly suitable of middle or small size LCD displays as claimed in claim 1, wherein a size of the LED backlight plate is a between 5 to 12 inches.

4. The LED backlight assembly suitable of middle or small size LCD displays as claimed in claim 1, wherein a size of the LED backlight plate is smaller than 5 inches.

5. The LED backlight assembly suitable of middle or small size LCD displays as claimed in claim 1, wherein a size of the LED backlight plate is 10.2 inches.

6. The LED backlight assembly suitable of middle or small size LCD displays as claimed in claim 1, wherein a size of the LED backlight plate is 7 inches.

7. The LED backlight assembly suitable of middle or small size LCD displays as claimed in claim 1, wherein a size of the LED backlight plate is 4.3 inches.
